(19) United States
(12) Patent Application Publication
(10) Pub. No.: US 2001/0027704 A1
(43) Pub. Date: Oct. 11, 2001

(54) Corkscrew with advertising feature

(76) Inventor: Doo Seok Kee, Buchen-si (KR)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/768,660

(22) Filed: Jan. 23, 2001

(30) Foreign Application Priority Data
Apr. 10, 2000 (KR) 2000-10152
Apr. 10, 2000 (KR) 2000-10153

(51) Int. Cl. B67B 7/04

(52) U.S. Cl. 81/3.48

(57) ABSTRACT

A corkscrew with an advertising feature is disclosed. This corkscrew has a housing of a half bottle form, such as a half of a miniature wine bottle. This housing, acting as a transverse handle of the corkscrew, has a service mark and/or an advertising expression on its rounded external surface by directly printing on the surface or attaching an advertising label to the surface. The corkscrew also has a cap opener on the housing, and so it is selectively used for drawing corks from bottles or for opening crown-shaped caps of bottles through a levering action. The housing also has a spiral holding means in its recessed space. A spiral assembly, consisting of a metal spiral and a support block axially integrated into a single body, is hinged to the spiral holding means at the support block. In the preferred embodiments, an advertising label is attached to the rounded external surface of the housing, thus accomplishing a desired advertising feature. The lower portion of the recessed space is covered with a cover plate having a magnet. The cap opener may be formed on the cover plate. The present invention also provides a set of two corkscrews, of which the magnets have opposite poles, thus allowing the two corkscrews to be magnetically attached to for the two halves of a complete bottle shape, as desired.

### FIELD OF THE INVENTION

The present invention relates, in general, to a corkscrew consisting of a metal spiral with a sharp point at one end and a transverse handle at the other end, used for drawing corks from bottles and, more particularly, to a corkscrew having a housing of a half bottle form, such as a half of a miniature wine bottle, the housing also acting as a transverse handle of the corkscrew, with a service mark and/or an advertising expression formed on the rounded external surface of the housing by directly printing on said surface or attaching an advertising label to the surface, thus accomplishing a desired advertising feature.

### BACKGROUND OF THE INVENTION

As well known to those skilled in the art, some alcoholic beverages, such as wine, are marketed in bottles with corks fitted in the mouths. In order to open such a wine bottle, it is necessary to draw the cork from the bottle using a corkscrew. Conventional corkscrews typically consist of a metal spiral with a sharp point at one end and a transverse handle at the other end. When it is desired to draw a cork from a bottle using such a corkscrew, the metal spiral is driven into the central portion of the cork with the transverse handle being firmly gripped by one hand of a user. Korean Patent Publication No. 86-2,067 discloses a corkscrew having a structure specifically designed to easily draw a mushroom-shaped cork from a bottle. That is, this Korean corkscrew has a mouth holder used for tightly receiving and holding the mouth of a bottle when drawing a cork from the bottle.

Most conventional corkscrews have a fixed structure, with the metal spirals being fixed to the transverse handles, and are somewhat dangerous due to the metal spirals with sharp points, and so it is necessary for users to always carefully handle and keep the corkscrews. That is, when such conventional corkscrews are carelessly kept within reach of children or other careless people, the metal spiral of the corkscrew may injure them. Therefore, most users keep the corkscrews in a closed space, such as the interior of a drawer, when the corkscrews are not used. This forces the users to rummage drawers for the corkscrews when it is desired to draw a cork from a bottle. The conventional corkscrews are thus finally inconvenient to users. In addition, the conventional corkscrews only have a limited function of drawing corks from bottles, and so it may be preferable to design the corkscrews to have other functions and collateral features, such as an advertising feature, in addition to such an original function of drawing corks from bottles.

### SUMMARY OF THE INVENTION

Accordingly, the present invention has been made keeping in mind the above problems occurring in conventional ones, and an object of the present invention is to provide a corkscrew, which has a housing of a half bottle form, such as a half of a miniature wine bottle, the housing also acting as a transverse handle, with a service mark and/or an advertising expression formed on the rounded external surface of the housing by directly printing on said surface or attaching an advertising label to the surface, thus accomplishing a desired advertising feature.

Another object of the present invention is to provide a corkscrew with an advertising feature, which has a cap opener on its housing of a half bottle form, and which is selectively used for drawing corks from bottles or for opening crown-shaped caps of bottles through a levering action.

In order to accomplish the above objects, the present invention provides a corkscrew, comprising: a housing acting as a transverse handle of the corkscrew, the housing having a half bottle form with both a rounded external surface forming a half bottle-shaped appearance of the housing and an internal surface defining a recessed space, the housing also having a spiral holding means formed on the surface of the recessed space at a central portion thereof; and a spiral assembly consisting of a spiral and a support block axially integrated into a single body, the spiral assembly being hinged to the spiral holding means at the support block.

In the above corkscrew, an advertising label is attached to the rounded external surface of the housing.

In an embodiment, the spiral holding means of the housing comprises two spaced hinge brackets formed on the surface of the recessed space and individually having a first hinge hole, while the support block of the spiral assembly is provided with a second hinge hole at a position corresponding to the first hinge holes of the two hinge brackets, thus being hinged to the two hinge brackets by a hinge pin.

In another embodiment, the spiral holding means of the housing comprises a box-shaped bracket mounted on the surface of the recessed space, with two bosses being formed on opposite sidewalls of the box-shaped bracket and individually having a first hinge hole.

In the corkscrew, the space is covered with a cover plate at a lower portion under the spiral holding means hinged to the spiral assembly, with a magnet externally set on the cover plate at a desired position.

A cap receiving opening is formed on the cover plate at a position opposite to the magnet and inclinedly receives a crown-shaped cap of a bottle when it is desired to open the cap through a levering action, with a levering piece integrally formed along one edge of the cap receiving opening and positioned under the edge of a skirt of the cap while opening the cap. In addition, a notch is formed on the top edge of the cover plate at a position corresponding to the support block of the spiral assembly, thus holding the support block and preventing a further rotating action of the spiral assembly toward the plate after the spiral assembly is fully rotated around the spiral holding means to its open position.

In a further embodiment, the spiral holding means of the housing comprises a box-shaped bracket mounted on the surface of the recessed space, while the spiral assembly is coupled to the box-shaped bracket through a connection block, with two bosses being formed at opposite side walls of the connection block and individually having a first hinge hole. In such a case, the support block of the spiral assembly has a second hinge hole at a position corresponding to the first hinge holes of the bosses, thus being hinged to the connection block by a hinge pin and being locked to the box-shaped bracket by an insertion of the connection block into the bracket.

In the corkscrew of this invention, two guide rails are formed along opposite side edges of the box-shaped bracket, while a plate-type sliding stopper movably engages with the guide rails. This sliding stopper is partially pulled from the guide rails to come into contact with a sidewall of the support block when the spiral assembly is fully rotated to its open position. The sliding stopper thus prevents the spiral assembly from being unexpectedly rotated from its open position to its closed position during a cork drawing process.

The present invention also provides a set of two corkscrews comprising first and second corkscrews. The two cork screws individually have the same construction as described above, but the magnets of the two corkscrews have opposite poles, thus allowing the two corkscrews to be magnetically attached to form a complete bottle shape, as desired.

In another embodiment, each of the two corkscrews may comprise a horizontal partition wall formed in the recessed space of the housing at a lower portion, thus forming a cap receiving opening at the lower portion, with a levering piece integrally formed along the partition wall and positioned under the edge of a skirt of a crown-shaped cap of a bottle while opening the cap through a levering action. In this embodiment, a magnet holder is formed in the recessed space at a position between the spiral assembly and the horizontal partition wall, with a magnet seated on the magnet holder. The magnets of the two corkscrews have opposite poles, thus allowing the two corkscrews to be magnetically attached to form a complete bottle shape, as desired.

The corkscrew of this invention may stand upright or may be laid on a support surface in a way such that the external surface having the advertising label is exposed to viewers. It is thus possible for viewers to view the advertising label and to be informed of the service mark and/or the advertising expression printed on the label. The corkscrew of this invention thus accomplishes a desired advertising feature in addition to its originally designed functions of drawing corks and/or opening caps from bottles.

On the other hand, the set of two corkscrews of this invention may stand upright on a support surface while magnetically integrating the two corkscrews into a complete bottle shape, with the external surfaces having the advertising labels exposed to viewers. The two corkscrews thus accomplish a desired advertising feature in addition to their originally designed functions of drawing corks and/or opening caps from bottles.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded rear perspective view of a corkscrew in accordance with the primary embodiment of the present invention, showing the construction of the corkscrew;

FIG. 2 is a front perspective view of the corkscrew according to the primary embodiment of this invention, showing the front appearance of the corkscrew;

FIG. 3 is a rear perspective view of the corkscrew according to the primary embodiment of this invention, showing an operation of the corkscrew;

FIG. 4 is an exploded rear perspective view of a corkscrew in accordance with the second embodiment of the present invention, showing the construction of the corkscrew;

FIG. 5 is an exploded rear perspective view of a corkscrew in accordance with the third embodiment of the present invention, showing the construction of the corkscrew;

FIG. 6 is a rear perspective view of the corkscrew according to the third embodiment of this invention, when the elements of the corkscrew are completely assembled into a single body;

FIG. 7 is a rear perspective view of the corkscrew according to the third embodiment of this invention, showing an operation of the corkscrew;

FIG. 8 is an exploded perspective view of a set of two corkscrews in accordance with the fourth embodiment of the present invention, when the corkscrews are separated from each other;

FIG. 9 is a sectional view of the two corkscrews according to the fourth embodiment of this invention, when the two corkscrews are attached to each other;

FIG. 10 is a perspective view of the two corkscrews according to the fourth embodiment of this invention, when the corkscrews are magnetically attached to each other;

FIG. 11 is an exploded rear perspective view of a corkscrew in accordance with the fifth embodiment of the present invention, showing the construction of the corkscrew;

FIG. 12 is a sectional view of two corkscrews according to the fifth embodiment of this invention, when the two corkscrews are magnetically attached to each other;

FIG. 13 is an exploded perspective view of a holding means for the spiral assembly of the corkscrew in accordance with the sixth embodiment of the present invention;

FIG. 14 is a sectional view of the corkscrew having the holding means according to the sixth embodiment of this invention;

FIG. 15 is an exploded perspective view of a holding means for the spiral assembly of the corkscrew in accordance with the seventh embodiment of the present invention;

FIG. 16 is a sectional view of the corkscrew having the holding means according to the seventh embodiment of this invention, showing an operation of the corkscrew;

FIG. 17 is an exploded rear perspective view of a corkscrew in accordance with the eighth embodiment of the present invention, showing the construction of the corkscrew; and

FIG. 18 is a sectional view of a set of two corkscrews according to the ninth embodiment of this invention, when the two corkscrews are magnetically attached to each other.

### DESCRIPTION OF THE PREFERRED EMBODIMENTS

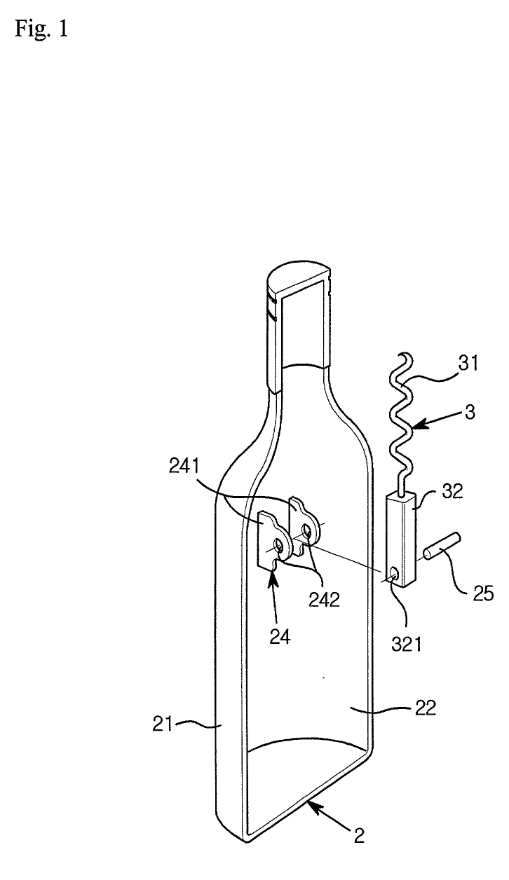

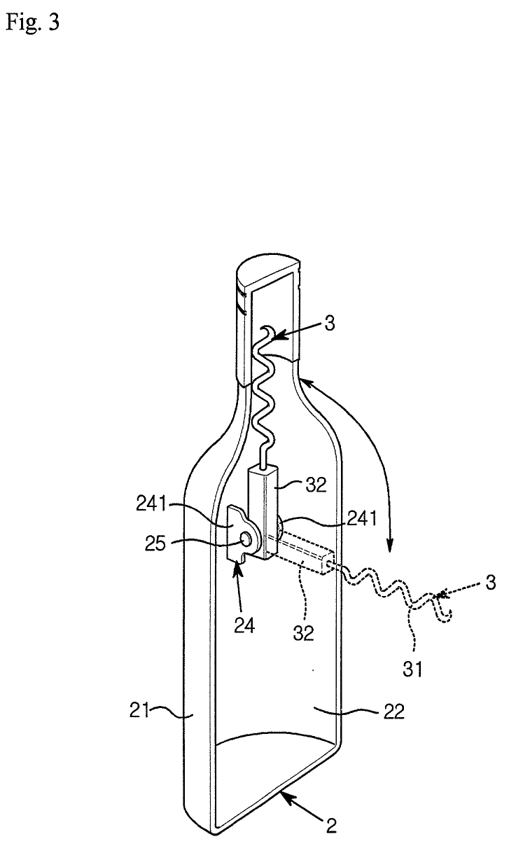

FIGS. 1 to 3 show a corkscrew with an advertising feature in accordance with the primary embodiment of the present invention.

As shown in FIG. 1, the corkscrew according to the primary embodiment of this invention comprises a housing 2 acting as a transverse handle of the corkscrew. This housing 2 has a half bottle form, and so the sidewall of the housing 2 has both a rounded external surface 21 forming a half bottle-shaped appearance and an internal surface forming a recessed space 22. It is preferable to close the upper and lower ends of the space 22.

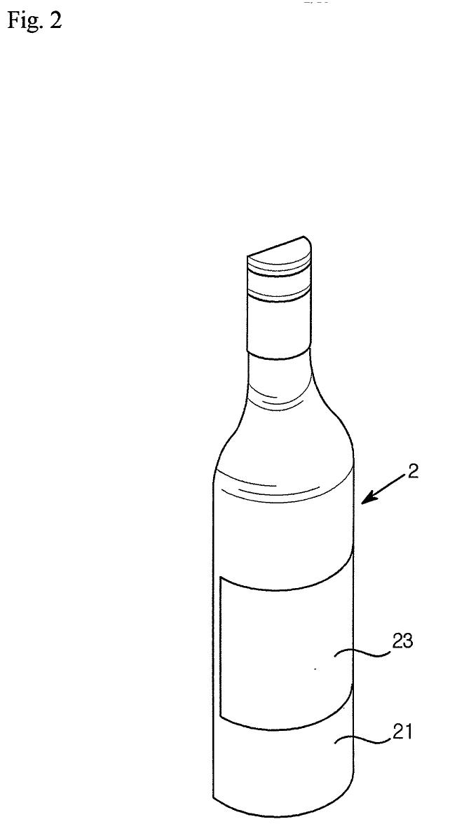

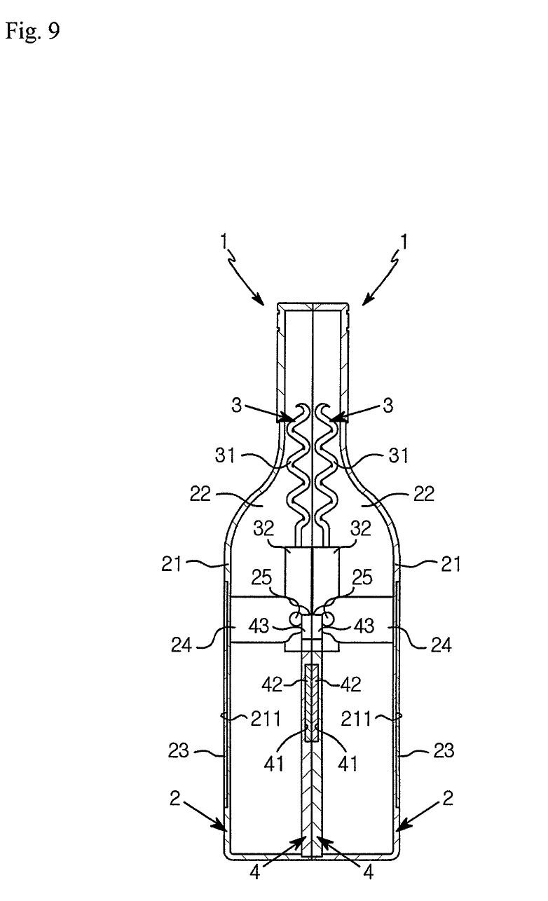

As shown in FIG. 2, it is also preferable to form a desired service mark and/or an advertising expression on the rounded external surface 21 of the housing 2, thus accomplishing a desired advertising feature. In the preferred embodiment, an advertising label 23 attached to the surface 21 accomplishes such an advertising feature. However, it should be understood that the advertising feature may be accomplished by directly printing a desired service mark and/or a desired advertising expression on the surface 21. In the present invention, a label seat 211 may be formed on the surface 21 by depressing the surface 21 at a desired area to form a shallow depression at the area as shown in FIG. 9. In such a case, it is preferable to design the depth of the shallow depression of the label seat 211 to be equal to the thickness of the label 23. Due to such a label seat 211, the label 23 is precisely attached to a desired portion of the surface 21.

A metal spiral holding means 24 is formed on the surface of the space 22 at a central portion. In the primary embodiment, the holding means 24 comprises two hinge brackets 241 individually having a first hinge hole 242. A metal spiral assembly 3 is hinged to the holding means 24.

The metal spiral assembly 3 comprises a metal spiral 31 and a support block 32, which are axially integrated into a single body. The metal spiral assembly 3 is hinged to the holding means 24 at the support block 32 using a hinge pin 25. In order to hinge the spiral assembly 3 to the holding means 24, the support block 32 is provided with a second hinge hole 321 at a position corresponding to the first hinge holes 242 of the hinge brackets 241. Therefore, the metal spiral assembly 3 is hinged to the holding means 24 of the housing 2 by the hinge pin 25 commonly passing through the three hinge holes 242 and 321, with the support block 32 of the assembly 3 interposed between the two brackets 241.

The corkscrew according to the primary embodiment of this invention may stand upright or may be laid on a support surface in a way such that the external surface 21 having the advertising label 23 is exposed to viewers. It is thus possible for viewers to view the advertising label 23 and to be informed of the service mark and/or the advertising expression printed on the label 23. When the half bottle form is originated from a certain famous commercial bottle design, the half bottle form itself serves as a good advertising feature. The corkscrew of this invention thus accomplishes a desired advertising feature in addition to its originally designed function of drawing corks from bottles.

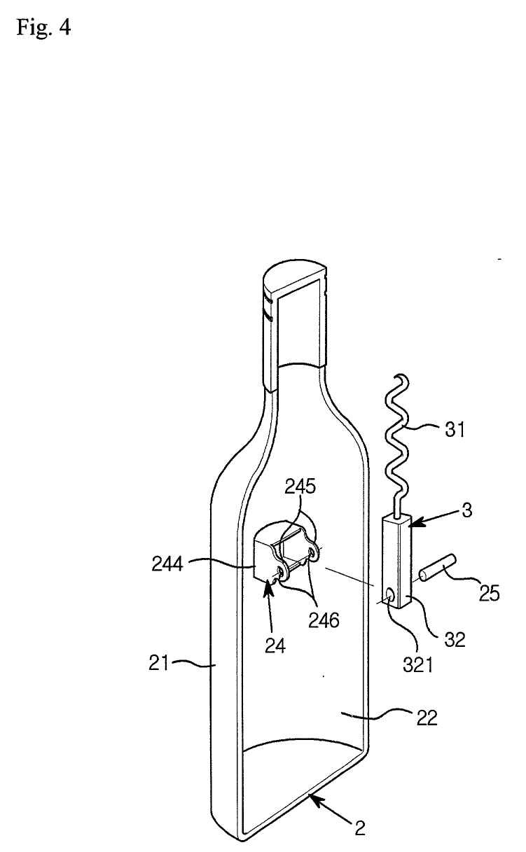

FIG. 4 is an exploded rear perspective view of a corkscrew with an advertising feature in accordance with the second embodiment of this invention.

As shown in the drawing, the general shape of the corkscrew according to the second embodiment remains the same as that of the primary embodiment, but the metal spiral holding means 24 is altered to consist of a box-shaped bracket 244, with two bosses 245 being formed on opposite sidewalls of the bracket 244. Those elements common to both the primary embodiment and the second embodiment will thus carry reference numerals and a further explanation for such elements is not deemed necessary. Each of the bosses 245 is provided with a first hinge hole 246 at a position corresponding to the second hinge hole 321 of the support block 32 of the metal spiral assembly 3. The metal spiral assembly 3 is hinged to the holding means 24 of the housing 2 by a hinge pin 25 commonly passing through the three hinge holes 246 and 321, with the support block 32 of the assembly 3 interposed between the two bosses 245.

The corkscrew according to the second embodiment of this invention is advantageous in that the structural strength of the metal spiral holding means 24 is improved since the means 24 consists of the box-shaped bracket 244 having two bosses 245.

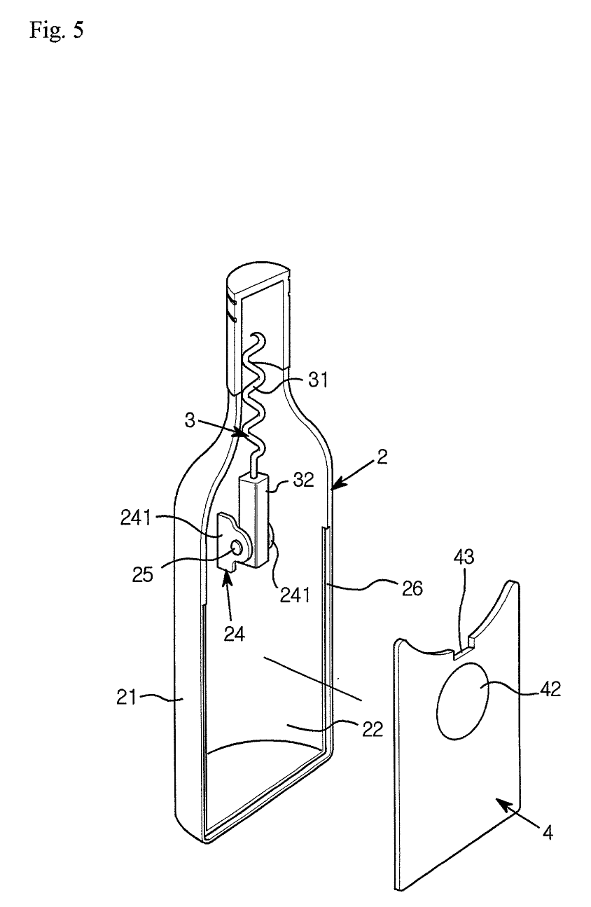

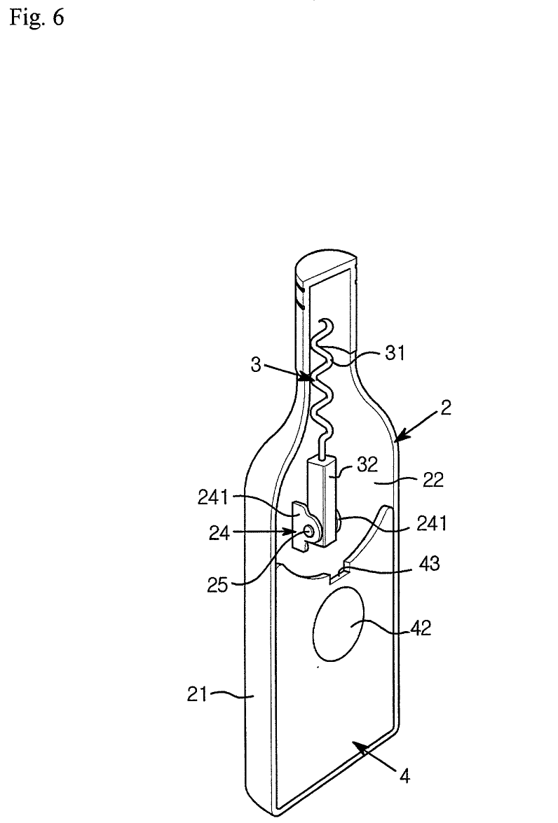

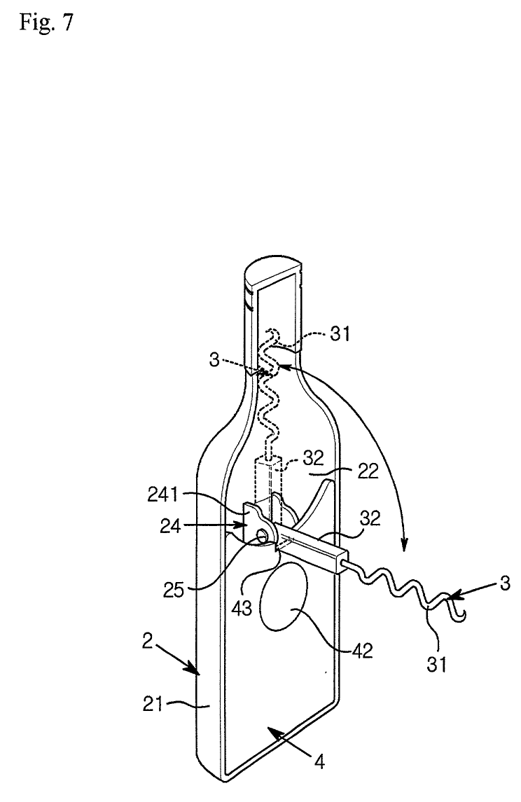

FIGS. 5 to 7 show a corkscrew with an advertising feature in accordance with the third embodiment of this invention.

As shown in the drawing, the general shape of the corkscrew according to the third embodiment remains the same as that described for the primary embodiment, but a cover plate 4 is mounted to the lower portion of the housing 2 so as to cover the lower portion of the space 22 in a way such that the plate 4 allows both the holding means 24 and the metal spiral assembly 3 to be exposed to the outside. Those elements common to both the primary embodiment and the second embodiment will thus carry reference numerals and a further explanation for such elements is not deemed necessary. A first magnet 42 is externally set on the cover plate 4 at a desired position.

In the third embodiment, the magnet 42 is received in the recessed seat 41 (see FIG. 9) and is attached to the bottom surface of the seat 41 using an adhesive, thus being firmly seated in the seat 41 without being unexpectedly removed from the seat 41. A step 26 is continuously formed along the bottom edge and the lower portion of the opposite side edges of the space 22 as shown in FIG. 5, thus receiving the three side edges of the cover plate 4 when mounting the plate 4 to the housing 2. This step 26 allows the cover plate 4 to be easily set on the housing 2 without forming any step at the junction between the housing 2 and the plate 4. In such a case, an adhesion process or a welding process preferably accomplishes the desired integration of the cover plate 4 with the housing 2.

When the cover plate 4 having the magnet 42 is attached to the housing 2 of the corkscrew as described above, it is possible to magnetically attach the corkscrew of this invention to a metal support surface in a way such that the external surface 21 having the advertising label 23 is exposed to viewers. It is thus possible for viewers to view the advertising label 23 and to be informed of the service mark and/or the advertising expression printed on the label 23. This corkscrew thus accomplishes a desired advertising feature in addition to its originally designed function of drawing corks from bottles.

When the spiral assembly 3 is fully rotated around the holding means 24 to its open position forming a T-shaped appearance of the corkscrew and is used for drawing a cork from a bottle, the spiral assembly 3 may be unexpectedly moved and may injure a user's hand. In order to prevent such a problem, the corkscrew according to the third embodiment preferably has a notch 43 on the top edge of the cover plate 4 at the central portion corresponding to the support block 32. Therefore, when the spiral assembly 3 is fully rotated around the holding means 24 to its open position, the support block 32 is seated in and stably held by the notch 43. It is thus possible to prevent an undesirable rotating action of the spiral assembly 3 toward the plate 4 while drawing a cork from a bottle using the corkscrew. This finally improves the operational safety of the corkscrews.

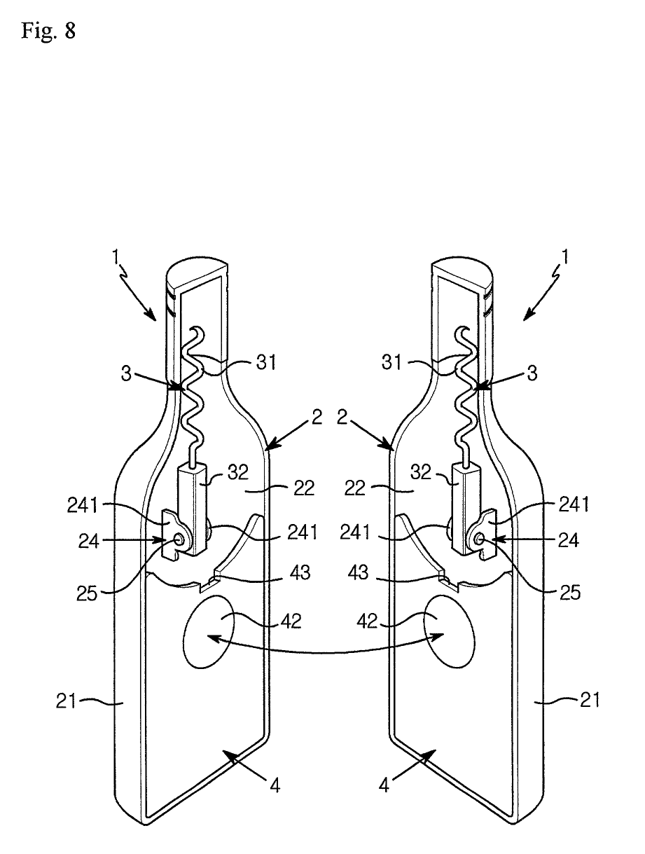

FIGS. 8 to 10 show a set of two corkscrews with an advertising feature in accordance with the fourth embodiment of the present invention.

In this embodiment, the general shape of each of the two corkscrews 1 remains the same as that described for the third embodiment, but the magnets 42 of the two corkscrews I have opposite poles, thus allowing the two corkscrews 1 to be magnetically attached to each other to form the two halves of a complete miniature bottle shape.

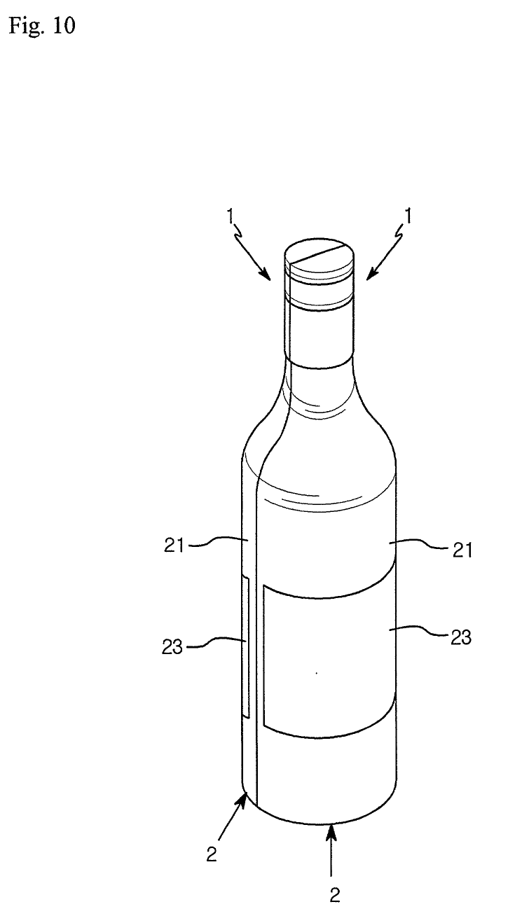

That is, the set of two corkscrews of this embodiment comprises first and second corkscrews 1 individually having a half bottle form, thus finally forming the two halves of a complete bottle shape as shown in FIG. 10 when the two corkscrews 1 are magnetically attached to each other by the two magnets 42 having the opposite poles.

The set of two corkscrews 1 according to the fourth embodiment of this invention may stand upright on a support surface while being magnetically attached to form the two halves of a complete bottle shape, with the external surfaces 21 having the advertising labels 23 exposed to viewers. It is thus possible for viewers to view the advertising labels 23 and to be informed of the service marks and/or the advertising expression printed on the labels 23. The set of two corkscrews 1 of this embodiment thus accomplishes a desired advertising feature in addition to their originally designed function of drawing corks from bottles.

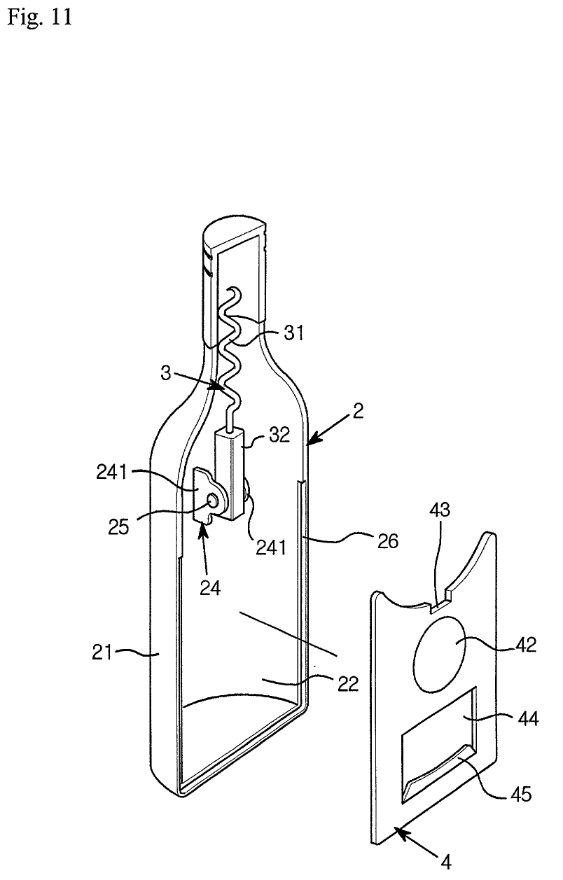

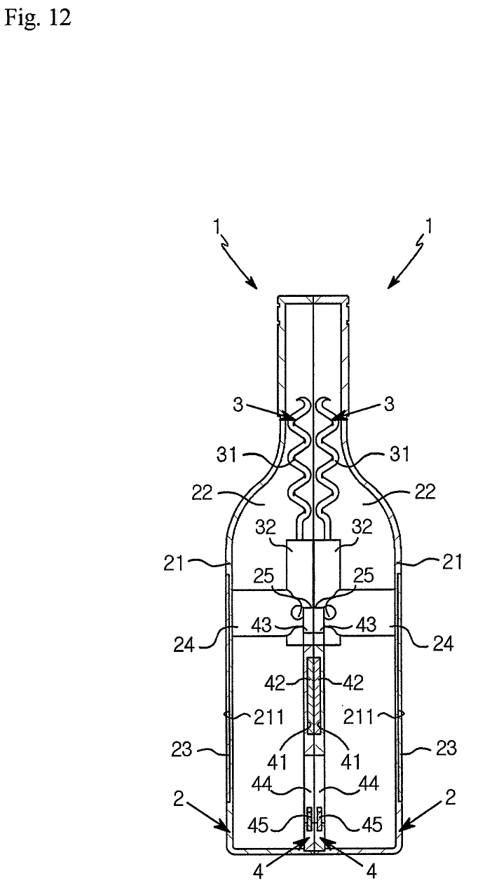

FIGS. 11 to 12 show a corkscrew with an advertising feature in accordance with the fifth embodiment of the present invention.

As shown in the drawings, the general shape of the corkscrew according to the fifth embodiment remains the same as that described for the third and fourth embodiments, but a bottle cap opening means is formed on the cover plate 4 and allows the corkscrew to be selectively used for drawing corks from bottles or for opening crown-shaped caps of bottles through a levering action. That is, a cap receiving opening 44 is formed on the cover plate 4 at a position opposite to the magnet 42. A levering piece 45 is integrally formed along one edge of the opening 44 opposite to the magnet 42 in a conventional manner.

In the corkscrew of this embodiment, the cover plate 4 having the cap opening means acts as a cap opener used for opening crown-shaped caps of bottles through a levering action. When it is desired to open a crown-shaped cap of a bottle through a levering action, the corkscrew is primarily and inclinedly positioned around the cap of the bottle. In such a case, the opening 44 of the cover plate 4 partially receives the cap until the edge of the opening 44, opposite to the levering piece 45, is brought into contact with the top surface of the cap and the levering piece 45 is stably positioned under the edge of the skirt of the cap. When the housing 2 is, thereafter, levered up by a user, one side of the cap of the bottle is bent upward and allows the cap to be removed from the mouth of the bottle. On the other hand, when it is desired to draw a cork from a bottle, such as a wine bottle, the spiral assembly 3 is fully rotated around the holding means 24 to its open position forming a T-shaped appearance of the corkscrew. Thereafter, the spiral 31 of the assembly 3 is driven into the cork prior to drawing the cork from the bottle. This embodiment provides a corkscrew integrated with a cap opener, thus allowing a user to be free from separately preparing a corkscrew and a cap opener and being convenient to the user.

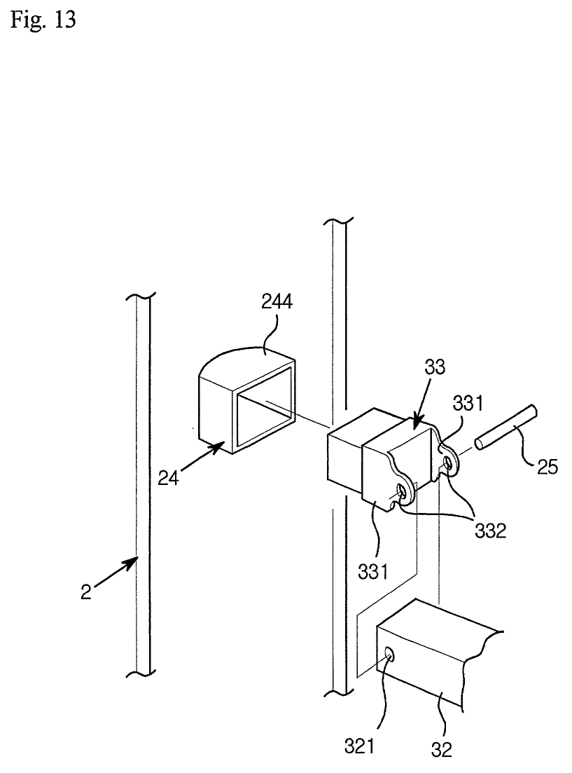

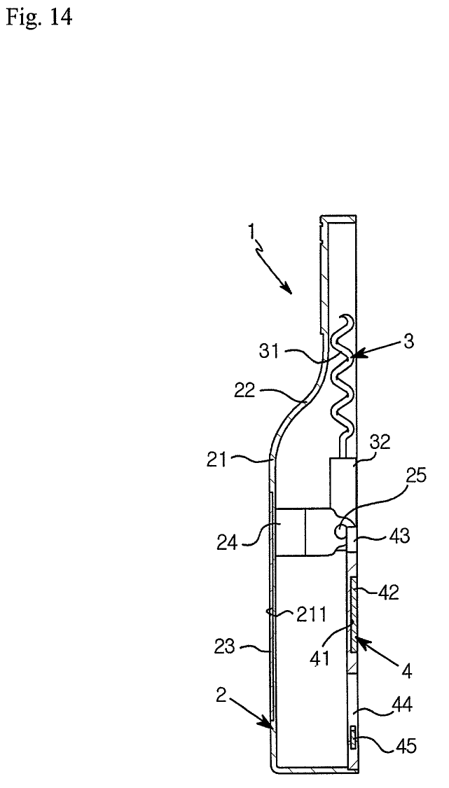

FIGS. 13 and 14 show a corkscrew with an advertising feature in accordance with the sixth embodiment of the present invention.

The corkscrew of this embodiment is specifically designed to allow the spiral assembly 3 to be easily assembled with the holding means 24 of the housing 2 regardless of a structural limit of the space 22. That is, the space 22 of the housing 2 is limited in its width, and so it is not easy to insert the hinge pin 25 into the hinge holes while assembling the support block 32 of the spiral assembly 3 with the holding means 24. In order to solve such a problem, the holding means 24 of this embodiment consists of a box-shaped bracket or recess 244 formed on the surface of the space 22, while the spiral assembly 3 consists of a metal spiral 31, a support block 32 and a connection block 33. In the corkscrew of this invention, the connection block 33 is hinged to the support block 32 using a hinge pin 25 and is tightly inserted into the box-shaped bracket or recess 244 of the holding means 24, thus accomplishing an easy assembling of the spiral assembly 3 with the holding means 24.

In a detailed description, the general shape of the box-shaped bracket 244 of this embodiment remains the same as that of the second embodiment, but two bosses 331, individually having a first hinge hole 332 corresponding to the second hinge hole 321 of the support block 32, are formed on opposite sidewalls of the connection block 33 in place of the bracket 244. The elements of this corkscrew are assembled into a single body as follows. The support block 32 is primarily hinged to the connection block 33 by the hinge pin 25 commonly passing through the three hinge holes 321 and 332, with the support block 32 of the assembly 3 interposed between the two bosses 331. The spiral assembly 3 is thus formed. Thereafter, the spiral assembly 3 is locked to the holding means 24 of the housing 2 by inserting the connection block 33 into the bracket 244 of the holding means 24, with an adhesive applied to the junction between the block 33 and the bracket 244. The spiral assembly 3 is thus hinged to the housing 2 of the corkscrew. In this embodiment, it is preferable to form a step in the insert part of the connection block 33, thus allowing the connection block 33 to be easily and precisely inserted into the bracket 244 of the holding means 24.

As described above, the corkscrew of this embodiment is produced by hinging the support block 32 to the connection block 33 by the hinge pin 25 so as to form a desired spiral assembly 3 prior to integrating the connection block 33 with the holding means 24 into a single body. Therefore, the corkscrew of this embodiment is easily produced with improved productivity and at a low production cost. Another advantage of this embodiment resides in that it is possible to simplify the shape of a mold for the housing 2 of the corkscrew.

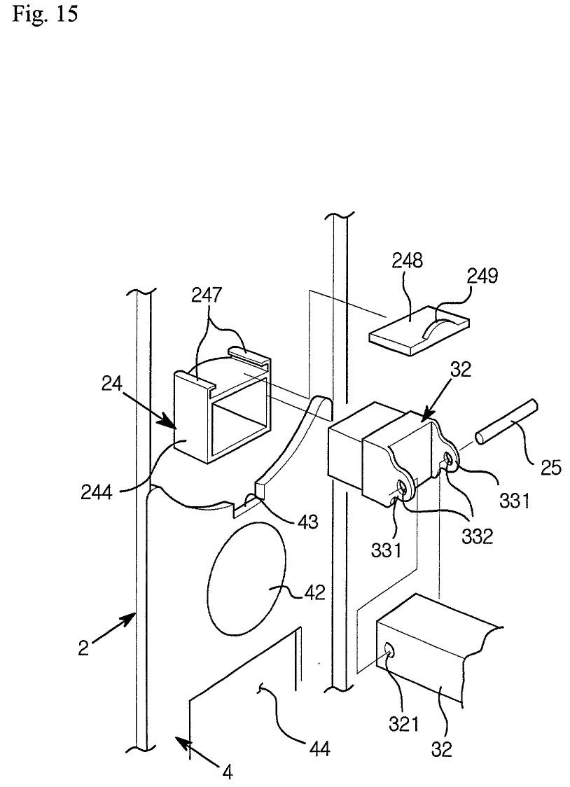

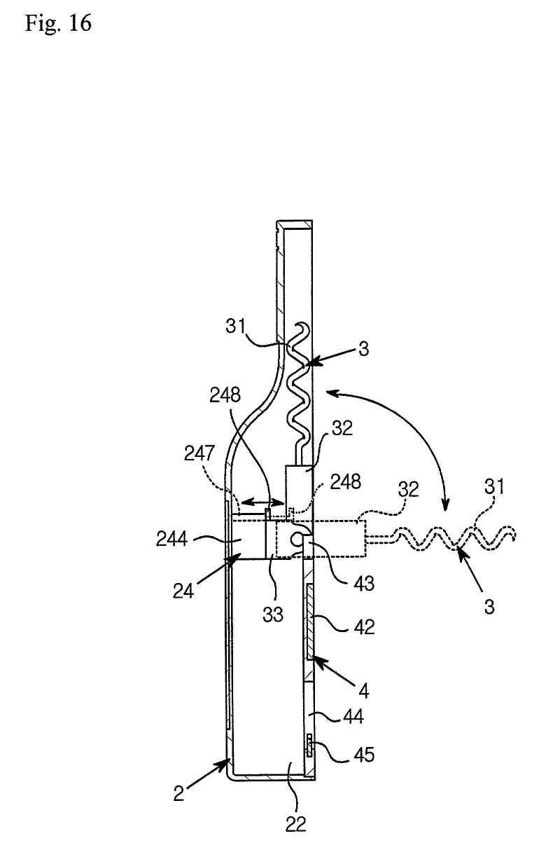

FIGS. 15 to 16 show a corkscrew with an advertising feature in accordance with the seventh embodiment of the present invention.

In this embodiment, the general shape of the corkscrew remains the same as that described for the sixth embodiment, but a structure, designed to more effectively prevent an unexpected movement of the spiral assembly 3 during a cork drawing operation, is added to the corkscrew. That is, when the spiral assembly 3 of the sixth embodiment is fully rotated to its open position, the support block 32 is seated into the notch 43 of the cover plate 4 and is prevented from being further rotated in the same direction by the notch 43. However, the notch 43 may regrettably fail to prevent the assembly 3 from being unexpectedly rotated to its closed position and may injure a user's hand while drawing a cork from a bottle using the corkscrew. In an effort to solve the problem, the corkscrew of this seventh embodiment has a means for preventing the spiral assembly 3 from being unexpectedly rotated to its closed position during a cork drawing process.

In order to accomplish the object of this embodiment, two guide rails 247 are formed on opposite side edges of the top surface of the bracket 244 of the holding means 24, while a plate-type sliding stopper 248 movably engages with the guide rails 247. Prior to starting a cork drawing operation using the corkscrew, the stopper 248 is partially pulled up from the guide rails 247 to be brought into contact with a sidewall of the support block 32 after the spiral assembly 3 is fully rotated from its closed position to its open position. In the above position, the stopper 248 prevents the spiral assembly 3 from being unexpectedly rotated to its closed position and from injuring a user's hand while drawing a cork from a bottle. In this embodiment, it is preferable to form a finger grip 249 on the outside edge of the stopper 248 so as to allow a user to easily manipulate the stopper 248.

When the stopper 248 is partially pulled up from the guide rails 247 to come into contact with the sidewall of the support block 32 after the spiral assembly 3 is fully rotated to its open position, the support block 32 is stably held by both the notch 43 of the cover plate 4 and the stopper 248 at its opposite side walls. Therefore, it is possible to almost completely prevent an undesirable movement of the spiral assembly 3 while drawing a cork from a bottle using the corkscrew. This finally improves the operational safety of the corkscrews.

Of course, it should be understood that the means for preventing the spiral assembly 3 from being unexpectedly rotated to its closed position during a cork drawing process may be altered in its structure without affecting the functioning of this invention. For example, both the guide rails 247 and the stopper 248 may be formed on the connection block 33 in place of the bracket 244.

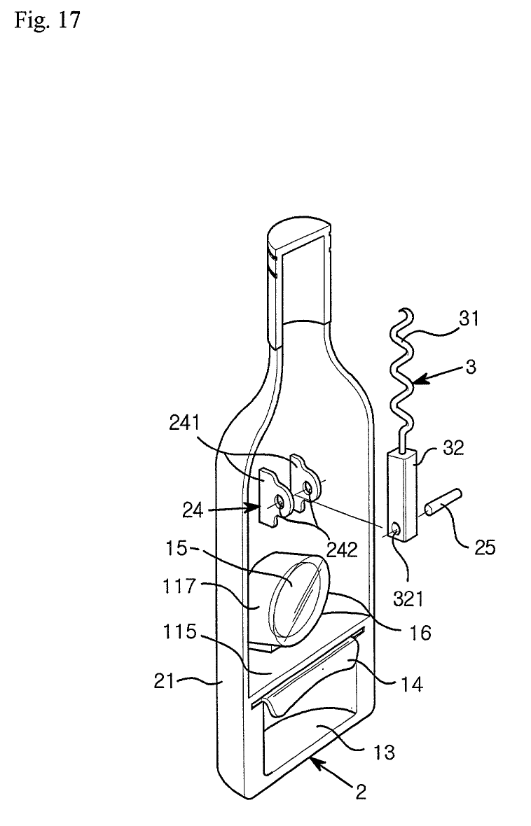

FIG. 17 shows a corkscrew with an advertising feature in accordance with the eighth embodiment of the present invention.

As shown in the drawing, the general shape of the corkscrew according to this embodiment remains the same as that described for the third and fifth embodiments, but both the cover plate 4 and the first magnet 42 are altered in structures as follows. For ease of description, the altered structure according to this embodiment, acting as the cover plate 4 and the magnet 42, is added to a corkscrew having the same construction as that of the primary embodiment.

In the corkscrew according to the eighth embodiment, the space 22 of the housing 2 is provided with a horizontal partition wall 115 at a lower portion, thus forming a cap receiving opening 13 at the position under the partition wall 115. A levering piece 14 is integrally formed along the partition wall 115. In addition, a cylindrical magnet holder 117 extends from the surface of the space 22 at a position between the spiral holding means 24 and the partition wall 115, with a second magnet 15 seated in the mouth of the magnet holder 117. In this embodiment, it is preferable to attach an additional advertising label 16 to the outside surface of the second magnet 15 so as to totally cover the magnet 15. This additional advertising label 16, covering the magnet 15, improves both the appearance and advertising effect of the corkscrew.

The corkscrew of this embodiment is selectively used for drawing corks from bottles or for opening crown-shaped caps of bottles through a levering action. When it is desired to open a crown-shaped cap of a bottle using this corkscrew, the corkscrew is primarily and inclinedly positioned around the cap of the bottle. In such a case, the opening 13 of the housing 2 partially receives the cap until the edge of the bottom wall of the opening 13, opposite to the levering piece 14, is brought into contact with the top surface of the cap and the levering piece 14 is stably positioned under the edge of the skirt of the cap. When the housing 2 is, thereafter, levered up by a user, one side of the cap is bent upward and allows the cap to be removed from the mouth of the bottle.

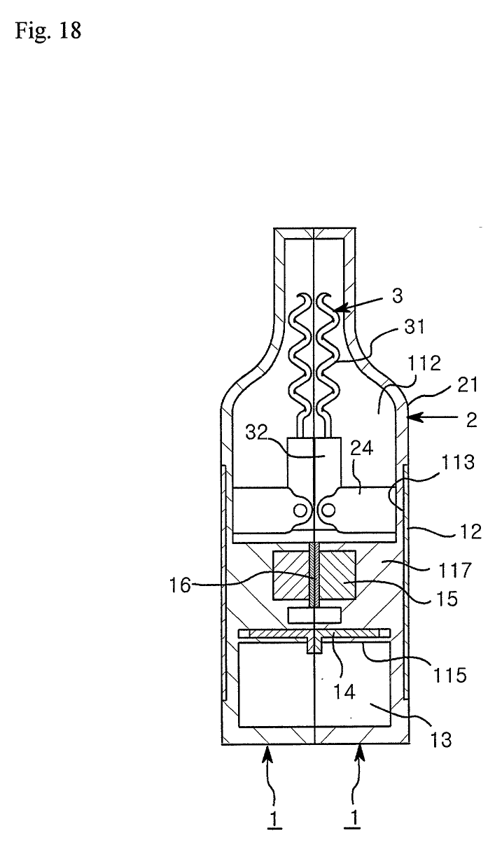

FIG. 18 is a sectional view of a set of two corkscrews according to the ninth embodiment of this invention, when the two corkscrews are magnetically attached to each other.

As shown in the drawing, the set of two corkscrews of this embodiment comprises first and second corkscrews 1, with the general shape of each of the two corkscrews 1 remaining the same as that described for the eighth embodiment. However, the magnets 15 of the two corkscrews 1 of this embodiment have opposite poles, thus allowing the two corkscrews 1 to be magnetically attached to each other to form the two halves of a complete miniature bottle shape, as desired. That is, the two corkscrews 1 of this embodiment individually have a half bottle form, thus finally forming the two halves of a complete bottle shape when the two corkscrews 1 are magnetically attached to each other by the two magnets 15 having the opposite poles.

In the above-mentioned embodiments, it should be understood that the structure for coupling the spiral assembly 3 and the holding means 24 may be somewhat freely modified without affecting the functioning of this invention.

As described above, the present invention provides a corkscrew having a housing of a half bottle form, such as a half of a miniature wine bottle. The housing acts as a transverse handle of the corkscrew, with a service mark and/or an advertising expression formed on the rounded external surface of the housing by directly printing on said surface or attaching an advertising label to the surface, thus accomplishing a desired advertising feature.

In an embodiment of this invention, the corkscrew is provided with a magnet capable of allowing a user to magnetically attach the corkscrew on a metal support surface in a way such that the service mark and/or the advertising expression formed on the housing is exposed to viewers. The corkscrew with the magnet is convenient to users while accomplishing a desired advertising feature.

Another embodiment of this invention provides a set of two corkscrews having magnets of opposite poles. When the two corkscrews are magnetically attached to each other, they form the two halves of a complete miniature bottle shape. The set of two corkscrews may stand upright on a support surface while being magnetically attached together, with the external surfaces having the advertising labels exposed to viewers. It is thus possible for viewers to view the advertising labels and to be informed of the service marks and/or the advertising expression printed on the labels. The set of two corkscrews of this embodiment thus accomplishes a desired advertising feature in addition to their originally designed function of drawing corks from bottles.

The corkscrew with an advertising feature according to this invention may be also provided with a cap opener on its housing of a half bottle form. In such a case, the corkscrew is selectively used for drawing corks from bottles or for opening crown-shaped caps of bottles through a levering action. The corkscrew, having such a cap opener, allows a user to be free from separately preparing a corkscrew and a cap opener, thus being convenient to the user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A corkscrew, comprising:
a housing acting as a transverse handle of the corkscrew, said housing having a half bottle form with both a rounded external surface forming a half bottle-shaped appearance and an internal surface defining a recessed space, said housing also having spiral holding means formed on the surface of the recessed space at a central portion; and
a spiral assembly consisting of a spiral and a support block axially integrated into a single body, said spiral assembly being hinged to said spiral holding means at the support block.

2. The corkscrew according to claim 1, wherein an advertising label is attached to the rounded external surface of said housing.

3. The corkscrew according to claim 1, wherein said spiral holding means of the housing comprises two spaced hinge brackets formed on the surface of the recessed space and individually having a first hinge hole, while said support block of the spiral assembly is provided with a second hinge hole at a position corresponding to the first hinge holes of the two hinge brackets, thus being hinged to the two hinge brackets by a hinge pin.

4. The corkscrew according to claim 1, wherein said spiral holding means of the housing comprises a box-shaped bracket mounted on the surface of the recessed space, with two bosses being formed on opposite sidewalls of said box-shaped bracket and individually having a first hinge hole, while said support block of the spiral assembly is provided with a second hinge hole at a position corresponding to the first hinge holes of the two bosses, thus being hinged to the two bosses by a hinge pin.

5. The corkscrew according to claim 1, wherein said space is covered with a cover plate at a lower portion under the spiral holding means hinged to the spiral assembly, with a magnet externally set on said cover plate at a desired position.

6. The corkscrew according to claim 5, wherein a cap receiving opening is formed on said cover plate at a position opposite to the magnet and inclinedly receives a crown-shaped cap of a bottle when it is desired to open the cap through a levering action, with a levering piece integrally formed along one edge of said cap receiving opening and positioned under the edge of a skirt of the cap while opening the cap.

7. The corkscrew according to claim 6, wherein a notch is formed on a top edge of said cover plate at a position corresponding to said support block of the spiral assembly, thus holding the support block and preventing a further rotating action of the spiral assembly toward the plate after the spiral assembly is fully rotated around the spiral holding means to its open position.

8. The corkscrew according to claim 1, wherein said spiral holding means of the housing comprises a box-shaped bracket mounted on the surface of said recessed space, while said spiral assembly is coupled to said box-shaped bracket through a connection block, with two bosses being formed at opposite side walls of the connection block and individually having a first hinge hole, said support block of the spiral assembly having a second hinge hole at a position corresponding to the first hinge holes of the bosses, thus being hinged to the connection block by a hinge pin and being locked to the box-shaped bracket by an insertion of the connection block into said bracket.

9. The corkscrew according to claim 8, wherein two guide rails are formed along opposite side edges of said box-shaped bracket, while a plate-type sliding stopper movably engages with said guide rails, said sliding stopper being partially pulled from the guide rails to come into contact with a sidewall of said support block when the spiral assembly is fully rotated to its open position, said sliding stopper thus preventing the spiral assembly from being unexpectedly rotated from its open position to its closed position during a cork drawing process.

10. The corkscrew according to claim 1, wherein said recessed space of the housing is provided with a horizontal partition wall at its lower portion, thus forming a cap receiving opening at a position under the partition wall, with a levering piece integrally formed along the partition wall and positioned under the edge of a skirt of a crown-shaped cap of a bottle while opening the cap through a levering action, said recessed space also having a magnet holder at a position between the spiral assembly and the horizontal partition wall, with a magnet seated on said magnet holder.

11. A set of two corkscrews, comprising:
first and second corkscrews individually consisting of:
a housing acting as a transverse handle of a corkscrew, said housing having a half bottle form with both a rounded external surface forming a half bottle-shaped appearance and an internal surface defining a recessed space, said housing also having spiral holding means formed on the surface of the recessed space at a central portion;
a spiral assembly consisting of a spiral and a support block axially integrated into a single body, said spiral assembly being hinged to said spiral holding means at the support block;
a horizontal partition wall formed in said recessed space of the housing at a lower portion, thus forming a cap receiving opening at the lower portion, with a levering piece integrally formed along the partition wall and positioned under the edge of a skirt of a crown-shaped cap of a bottle while opening the cap through a levering action; and
a magnet holder formed in said recessed space at a position between the spiral assembly and the horizontal partition wall, with a magnet seated on said magnet holder,
whereby the magnets of the two corkscrews have opposite poles, thus allowing the two corkscrews to be magnetically attached to form two halves of a complete bottle shape, as desired.

12. A set of two corkscrews, comprising:
first and second corkscrews individually consisting of:
a housing acting as a transverse handle of a corkscrew, said housing having a half bottle form with both a rounded external surface forming a half bottle-shaped appearance and an internal surface defining a recessed space, said housing also having spiral holding means formed on the surface of the recessed space at a central portion;
a spiral assembly consisting of a spiral and a support block axially integrated into a single body, said spiral assembly being hinged to said spiral holding means at the support block; and
a magnet mounted to a desired position in the recessed space,
whereby the magnets of the two corkscrews have opposite poles, thus allowing the two corkscrews to be magnetically attached to form two halves of a complete bottle shape, as desired.
